(19) United States
(12) Patent Application Publication
(10) Pub. No.: US 2025/0042153 A1
(43) Pub. Date: Feb. 6, 2025

(54) LIQUID EJECTION HEAD AND METHOD FOR EJECTING LIQUID

(71) Applicant: CANON KABUSHIKI KAISHA, Tokyo (JP)

(72) Inventors: KOICHI ISHIDA, Tokyo (JP); SHUZO IWANAGA, Kanagawa (JP); KEIJI TOMIZAWA, Kanagawa (JP); TAKATSUGU MORIYA, Tokyo (JP); SO AIZAWA, Kanagawa (JP); YOSHIHIRO HAMADA, Kanagawa (JP); FUMI TANAKA, Kanagawa (JP); TOMOHIRO SATO, Tokyo (JP)

(21) Appl. No.: 18/791,197

(22) Filed: Jul. 31, 2024

(30) Foreign Application Priority Data
Aug. 1, 2023 (JP) 2023-125728

(51) Int. Cl. B41J 2/14; B41J 2/175; B41J 2/18

(52) U.S. Cl. CPC B41J 2/1404; B41J 2/1433; B41J 2/175; B41J 2/18

(57) ABSTRACT

A liquid ejection head includes a liquid chamber having an element that generates thermal energy, a discharge port for liquid, a nozzle that communicates between the discharge port and the liquid chamber, and a liquid supply path and a liquid collection path in communication with the liquid chamber on opposite sides. The thermal energy forms a bubble in the liquid chamber, and the formed bubble enters the nozzle to eject liquid under pressure of the bubble. In a state where at least a portion of the bubble in the nozzle has a velocity component toward a surface of the liquid chamber that has the element and before liquid to be ejected comes in contact with the surface of the liquid chamber by being drawn into the liquid chamber by contraction of the bubble, the bubble communicates with an atmosphere and the liquid is ejected through the discharge port.

### BACKGROUND

### Field of the Disclosure

The present disclosure relates to a liquid ejection head and a method for ejecting liquid.

### Description of the Related Art

A typical example of a method for ejecting liquid employed in a liquid ejection head, such as an inkjet head, is a thermal ejection method that involves applying heat to liquid (for example, ink) for film boiling and ejecting the liquid by using the bubbling force caused by the film boiling. The liquid ejection head for the thermal ejection method includes a pressure chamber that provides force to eject liquid, a heat generating resistor (heater) in the pressure chamber, a channel through which liquid is supplied to the pressure chamber, and an element substrate that has a supply port through which liquid is supplied to the channel. Liquid is ejected through a discharge port in the element substrate by the energy generated by the heat generating resistor.

When the above-described thermal liquid ejection head ejects liquid, the ejected liquid has a columnar shape having a main droplet and an elongated tail (hereinafter, referred to as a tail) extending from the rear of the main droplet. The tail is separated from the main droplet due to the surface tension of the liquid during the flight of the droplet and becomes a fine droplet (sub-droplet, satellite). The satellite may land on a recording medium at a position away from the main droplet, lowering image quality. Of the satellites, a particularly fine satellite does not reach the recording medium and becomes a floating droplet (hereinafter may be referred to as mist). The mist may dirty a liquid ejection apparatus, such as an inkjet printer, and the dirt on the liquid ejection apparatus may be transferred to the recording medium, dirtying the recording medium.

Japanese Patent Laid-Open No. 2017-124600 discloses a configuration of a liquid ejection head that can shorten the tail of the droplet to prevent deterioration of image quality caused by satellites. In the liquid ejection head that has a projection in the discharge port, thermal energy generates a bubble in the pressure chamber, and the generated bubble enters the nozzle and forces the liquid to be ejected through the outlet under the pressure of the bubble. It is described that the configuration that allows the bubble entered the nozzle to communicate with the atmosphere at a position outside the discharge port shortens the tail of the droplet and thus reduces satellites.

A study found a new problem that the tail of the droplet tends to be unstable in the configuration of the liquid ejection head and the method for ejecting liquid disclosed in Japanese Patent Laid-Open No. 2017-124600. It has been found that if long-continued ejection is performed without any recovery action, such as an action of wiping off the area near the discharge port with a wiper, foreign substances may accumulate near the discharge port, significantly deviating the landing position of the ejected droplet.

### SUMMARY

The present disclosure provides a liquid ejection head and a method of ejecting liquid that have ejection stability during long-continued ejection while reducing generation of satellites by shortening the tail. The present disclosure, which solves the above-described problem, is a liquid ejection head including: a liquid chamber having an element that generates thermal energy for ejecting liquid; a discharge port through which liquid is ejected; a nozzle that communicates between the discharge port and the liquid chamber; a liquid supply path that is in communication with the liquid chamber and through which liquid is supplied to the liquid chamber; and a liquid collection path that is in communication with the liquid chamber on an opposite side of the liquid chamber from the liquid supply path and through which liquid is collected. The thermal energy forms a bubble in the liquid chamber, and the formed bubble enters the nozzle to eject liquid through the discharge port under pressure of the bubble. In a state where at least a portion of the bubble in the nozzle has a velocity component toward a surface of the liquid chamber that has the element and before liquid to be ejected through the discharge port comes in contact with the surface of the liquid chamber by being drawn into the liquid chamber by contraction of the bubble, the bubble communicates with an atmosphere and the liquid is ejected through the discharge port.

Further features of the present disclosure will become apparent from the following description of exemplary embodiments with reference to the attached drawings.

### BRIEF DESCRIPTION OF THE DRAWINGS

FIG. 1 is a view illustrating a liquid ejection apparatus according to one or more aspects of the present disclosure.

FIG. 2 is a conceptual diagram of a control system according to one or more aspects of the present disclosure.

FIG. 3 is a schematic view illustrating a liquid circulation route according to one or more aspects of the present disclosure.

FIGS. 4A and 4B are perspective views illustrating a liquid ejection head according to one or more aspects of the present disclosure.

FIG. 5 is an exploded perspective view of the liquid ejection head according to one or more aspects of the present disclosure.

FIGS. 6A to 6D are plan views of a channel member according to one or more aspects of the present disclosure.

FIG. 7A is a transparent view of the channel member according to one or more aspects of the present disclosure, and FIG. 7B is a cross-sectional view of the channel member.

FIG. 8A is a perspective view of an ejection module according to one or more aspects of the present disclosure, and FIG. 8B is an exploded perspective view of the ejection module.

FIGS. 9A to 9C are plan views of an element substrate according to one or more aspects of the present disclosure.

FIG. 10 is a cross-sectional perspective view of the element substrate according to one or more aspects of the present disclosure.

FIGS. 11A and 11B are schematic views illustrating a temperature control unit included in the element substrate according to one or more aspects of the present disclosure.

FIG. 12 is a partial magnified plan view illustrating adjacent portions of the element substrates according to one or more aspects of the present disclosure.

FIG. 13A is a plan view illustrating the inside of the liquid ejection head according to one or more aspects of the present disclosure, and FIG. 13B is a cross-sectional view illustrating the inside of the liquid ejection head.

FIGS. 14A and 14B are magnified plan views of an area including a discharge port of the liquid ejection head according to one or more aspects of the present disclosure.

FIGS. 15A to 15D are schematic views illustrating a transient ejection process in Comparative Example 1.

FIGS. 16A to 16D are schematic views illustrating a transient ejection process in Comparative Example 1.

FIGS. 17A to 17H are schematic views illustrating a transient ejection process in Comparative Example 2.

FIGS. 18A to 18G are schematic views illustrating a transient ejection process according to one or more aspects of the present disclosure.

FIG. 19 is a diagram indicating the relationship between the time elapsed from the start of generation of a bubble and the volume of the bubble in the transient ejection process according to one or more aspects of the present disclosure.

FIG. 20 is a diagram indicating the relationship between a distance OH between a bottom of a pressure chamber and the discharge port and the time Tₜₕ−Tₘₐₓ from when the bubble size reaches its maximum value until the bubble communicates with the atmosphere.

FIG. 21 is a diagram indicating the distance OH between the bottom of the pressure chamber and the discharge port and the time T_{fall}−Tₜₕ from when the bubble communicates with the atmosphere until the tail falls on the substrate.

### DESCRIPTION OF THE EMBODIMENTS

Hereinafter, an embodiment of the present disclosure will be described with reference to the drawings. However, the following description should not be construed as limiting the scope of the present disclosure. A liquid ejection head and a liquid ejection apparatus including the liquid ejection head of the present disclosure are applicable to devices, such as an inkjet printer, a copier, a facsimile having a communication system, and a word processor having a printer section. They are also applicable to industrial recording apparatuses used in combination with various processing devices. For example, they can be used to produce biochips, print electronic circuits, and semiconductor substrates.

The liquid ejection apparatus of the present embodiment has a configuration in which liquid, such as ink, is circulated between a tank and a liquid ejection head but may have a different configuration. For example, without circulation of liquid, the liquid ejection apparatus may have two tanks at the upstream and downstream sides of the liquid ejection head. Liquid flowing from one tank to the other tank causes the liquid in the pressure chamber to flow. The present embodiment is a line head (page-width head) that has a length corresponding to the width of the recording medium. However, the present disclosure is also applicable to a serial liquid ejection head, which performs recording while moving over a recording medium. The serial liquid ejection head may have a configuration that includes an element substrate for a black ink and an element substrate for a color ink, but this should not be construed as limiting. A short line head may include several element substrates arranged such that the discharge ports overlap with each other in a discharge port arrangement direction to have a shorter length than the width of the recording medium, and the line head may move over the recording medium.

Hereinafter, an embodiment of the present disclosure will be described with reference to the drawings.

### First Embodiment

### Overall Configuration of Apparatus

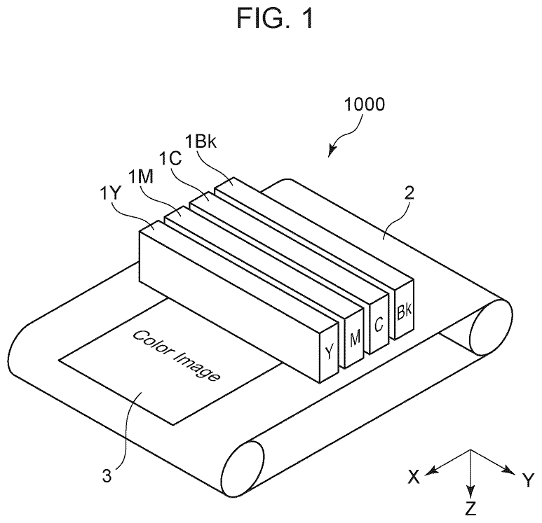

FIG. 1 illustrates an example of a liquid ejection apparatus of the present embodiment. The liquid ejection apparatus of this embodiment is a liquid ejection apparatus 1000 (hereinafter may be referred to simply as an apparatus 1000) in the form of an inkjet printer that records a color image on a recording medium 3 by ejecting yellow (Y), magenta (M), cyan (C), and black (Bk) inks. In the drawings, the X direction is the transportation direction of the recording medium 3, the Y direction is the width direction of the recording medium, and the Z direction is the direction that intersects the X and Y directions and is the direction in which liquid is ejected.

FIG. 1 illustrates the apparatus 1000 that includes a liquid ejection head 1 configured to directly apply ink to the recording medium 3 transported in the X direction. The recording medium 3 is placed on a transportation section 2 and transported in the X direction at a predetermined speed under four liquid ejection heads 1 (1Y, 1M, 1C, 1Bk) that eject different inks. In FIG. 1, the four liquid ejection heads 1Bk, 1C, 1M, and 1Y are arranged in the X direction in this order, and black, cyan, magenta, and yellow inks are applied onto the recording medium 3 in this order. In each of the liquid ejection heads 1, ink discharge ports, through which ink is ejected, are arranged in the Y direction.

In FIG. 1, a cut sheet is illustrated as the recording medium 3, but the recording medium 3 may be continuous roll paper. The recording medium is not limited to paper, but may be a film, for example.

In the liquid ejection apparatus of this embodiment, one liquid ejection head ejects a single color of ink, but one liquid ejection head may eject multiples colors of inks. Alternatively, the liquid ejection head may eject a liquid other than ink, such as a reaction liquid and an overcoating agent.

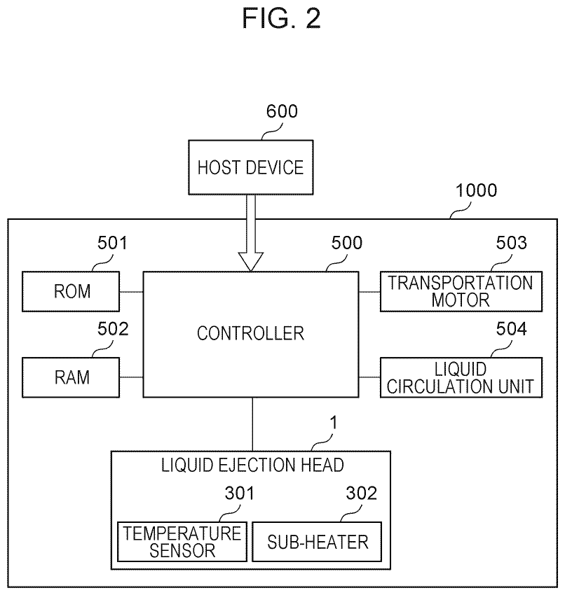

FIG. 2 is a block diagram illustrating a control configuration of the liquid ejection apparatus 1000. A controller 500 includes a CPU and other components and controls the entire liquid ejection apparatus 1000 in accordance with programs and various parameters stored in ROM 501 while using RAM 502 as a work area. The controller 500 performs predetermined image processing on image data sent from an externally connected host device 600 in accordance with programs and parameters stored in the ROM 501 to generate ejection data for ejection from the liquid ejection head 1. The liquid ejection head 1 is then driven in accordance with this ejection data to eject ink at a predetermined frequency.

During the ejection operation by the liquid ejection head 1, the controller 500 drives a transportation motor 503 to transport the recording medium 3 in the X direction at a speed corresponding to the drive frequency. Thus, an image in accordance with the image data sent from the host device 600 is recorded on the recording medium 3. The ROM 501 rewritably stores, for each of the liquid ejection heads 1, information on the area of the discharge ports available for ejection from the liquid ejection head 1.

### Liquid Circulation Route

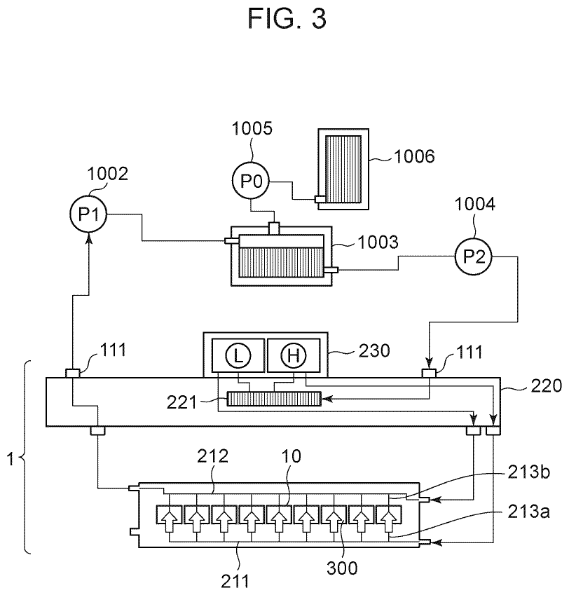

FIG. 3 schematically illustrates a liquid circulation route in the liquid ejection apparatus of the present embodiment. The liquid ejection head 1 is connected to a first circulation pump 1002, a buffer tank 1003, and other components so as to allow circulation of liquid. FIG. 3 illustrates only an ink flowing route in the liquid ejection head for one color of ink. However, the apparatus 1000 has circulation routes corresponding to the types of liquid, such as ink, to be ejected.

The buffer tank 1003 as a sub tank, which is connected to a main tank 1006, has an atmosphere communication hole (not illustrated) that communicates between the inside and the outside of the tank, allowing bubbles in the ink to be discharged to the outside. The buffer tank 1003 is also connected to a refill pump 1005. When the liquid in the liquid ejection head 1 is consumed by ejection (discharging) of ink for recording or suction recovery, which require ink ejection through the discharge ports of the liquid ejection head, the refill pump 1005 sends the consumed amount of ink from the main tank 1006 to the buffer tank 1003.

The first circulation pump 1002 has a function of drawing liquid from a liquid connection portion 111 of the liquid ejection head 1 and sends it to the buffer tank 1003. When the liquid ejection head 1 is driven, the first circulation pump 1002 makes ink flow through a common collection channel 212 at a constant amount.

A negative pressure control unit 230 is located on a route between a second circulation pump 1004 and a liquid ejection unit 300. The negative pressure control unit 230 is configured to keep the pressure downstream of the negative pressure control unit 230 (side adjacent to the liquid ejection unit 300) at a preset constant pressure even when the flow rate of the circulation system fluctuates due to differences in Duty of recording.

As illustrated in FIG. 3, the negative pressure control unit 230 has two pressure regulators set to have different regulated pressures. Of the two pressure regulators, one set at a relatively high pressure (negative pressure control unit 230H, indicated by H in FIG. 3) and one set at a relatively low pressure (negative pressure control unit 230L, indicated by L in FIG. 3) are connected to a common supply channel 211 and a common collection channel 212 of the liquid ejection unit 300, respectively, via a liquid supply unit 220. The liquid ejection unit 300 has individual supply channels 213a and individual collection channels 213b in communication with the element substrates 10 having the common supply channel 211, the collection channel 212, and the discharge ports. The element substrate will be described in detail later. Since the individual channel 213 is in communication with the common supply channel 211 and the common collection channel 212, the liquid pumped by the second circulation pump 1004 partly flows from the common supply channel 211 to the common collection channel 212 through the internal channel of the element substrate 10 (indicated by arrows in FIG. 3). This is due to the fact that there is a difference in pressure between the pressure regulator H, which is connected to the common supply channel 211, and the pressure regulator L, which is connected to the common collection channel 212, and that the first circulation pump 1002 is connected only to the common collection channel 212.

In this way, the liquid ejection unit 300 has a flow of liquid passing through the common collection channel 212 and a flow of liquid flowing from the common supply channel 211 to the common collection channel 212 through the element substrates 10. The flow flowing from the common supply channel 211 to the common collection channel 212 allows the heat generated in each element substrate 10 to be released to the outside of the element substrate 10. This configuration also allows, during recording by the liquid ejection head 1, ink to flow through the discharge ports and the pressure chambers that are not in use, reducing ink thickening in those areas. This configuration also allows thickened ink and foreign substances in the ink to be discharged into the common collection channel 212. Thus, the liquid ejection head 1 according to this embodiment can perform high-speed and high-quality recording.

### Configuration of Liquid Ejection Head

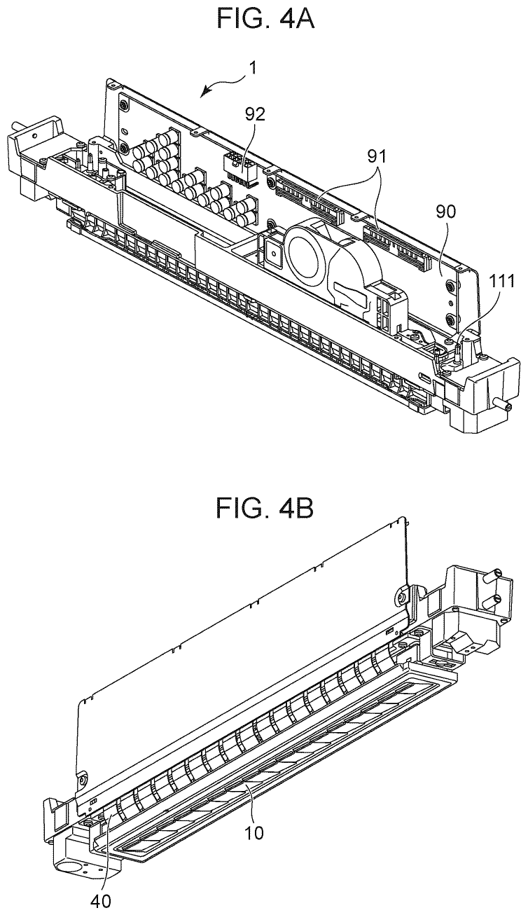

FIGS. 4A and 4B are perspective views illustrating the liquid ejection head 1 according to the present embodiment. The liquid ejection head 1 is a line type liquid ejection head having 17 element substrates 10 capable of ejecting ink and arranged in a straight line (arranged in-line). As illustrated in FIGS. 4A and 4B, the liquid ejection head 1 has the element substrates 10, a signal input terminal 91 and a power supply terminal 92 electrically connected via an electrical wiring board (flexible wiring board) 40 and an electrical wiring board 90. The signal input terminal 91 and the power supply terminal 92, which are electrically connected to the controller of the apparatus 1000, provide an ejection drive signal and the power necessary for ejection, respectively, to the element substrate 10. The consolidation of the wiring by the electrical circuit of the electrical wiring board 90 can make the number of signal input terminals 91 and power supply terminals 92 smaller than the number of element substrates 10. This reduces the number of electric connection units which must be removed when the liquid ejection head 1 is attached to the apparatus 1000 or when the liquid ejection head 1 is replaced. As illustrated in FIG. 4A, the liquid connection portion 111 at one end of the liquid ejection head 1 is connected to the liquid supply system of the apparatus 1000. This allows supply of ink from the supply system of the apparatus 1000 to the liquid ejection head 1 and collection of ink from the liquid ejection head 1 to the supply system of the apparatus 1000. Thus, the ink can be circulated through the route of the apparatus 1000 and the route of the liquid ejection head 1.

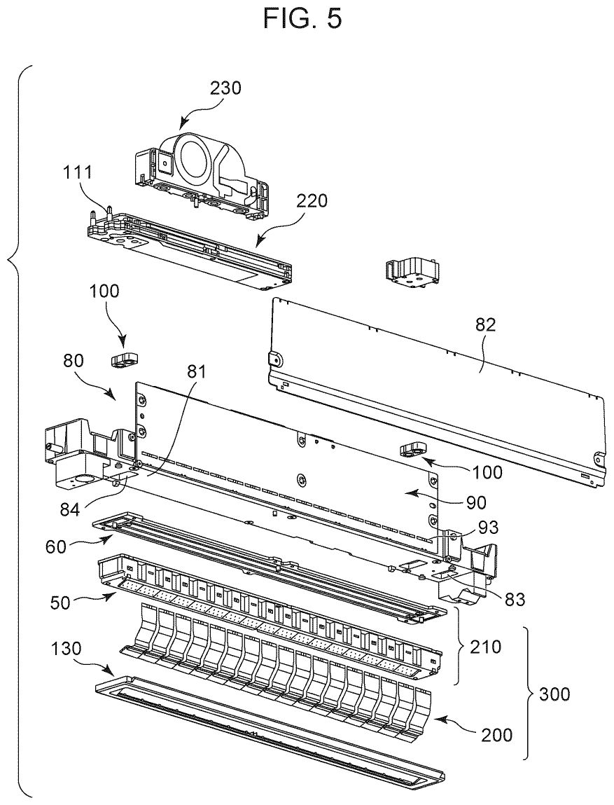

FIG. 5 is an exploded perspective view of components or units of the liquid ejection head 1. The liquid ejection unit 300, the liquid supply unit 220, and the electrical wiring board 90 are attached to a housing 80. The liquid supply unit 220 has the liquid connection portions 111 and further, in the liquid supply unit 220, a filter 221 (FIG. 3) that is in communication with the openings of the liquid connection portions 111 to remove foreign substances in the supplied ink. The liquid passing through the filter 221 flows to the negative pressure control unit 230 on the liquid supply unit 220. The negative pressure control unit 230 includes units having pressure regulating valves and uses the action of a valve, a spring member, or the like in each of the units to drastically attenuate a pressure loss change in the supply system (the upstream supply system of the liquid ejection head 1) of the apparatus 1000, which may occur with variation in the flow rate of the liquid.

This can stabilize a negative pressure change in an area downstream of the negative pressure control unit 230 (side adjacent to the liquid ejection unit 300) within a predetermined range. The negative pressure control unit 230 has two built-in pressure regulating valves set at different control pressures. The pressure regulating valve set at a higher pressure and the pressure regulating valve set at a lower pressure are in communication with the common supply channel 211 and the common collection channel 212 of the liquid ejection unit 300, respectively, via the liquid supply unit 220.

The housing 80 has a liquid ejection unit support 81 and an electrical wiring board support 82 to support the liquid ejection unit 300 and the electrical wiring board 90 and enhances the rigidity of the liquid ejection head 1. The electrical wiring board support 82, which supports the electrical wiring board 90, is fixed to the liquid ejection unit support 81 with screws. The liquid ejection unit support 81 has openings 83 and 84 that receive joint rubbers 100. The liquid supplied from the liquid supply unit 220 is introduced to a second channel member 60, which is included in the liquid ejection unit 300, through the joint rubber 100.

Next, the configuration of a channel member 210 included in the liquid ejection unit 300 will be described. As illustrated in FIG. 5, the channel member 210 is a stack of a first channel member 50 and the second channel member 60. A plurality of ejection modules 200 are bonded to a bonding surface of the first channel member 50 by an adhesive (not illustrated). The channel member 210 distributes the liquid supplied from the liquid supply unit 220 to the ejection modules 200 and returns the liquid flowing out of the ejection modules 200 to the liquid supply unit 220. The channel member 210 is fixed to the liquid ejection unit support 81 with screws, reducing warping and deformation of the channel member 210.

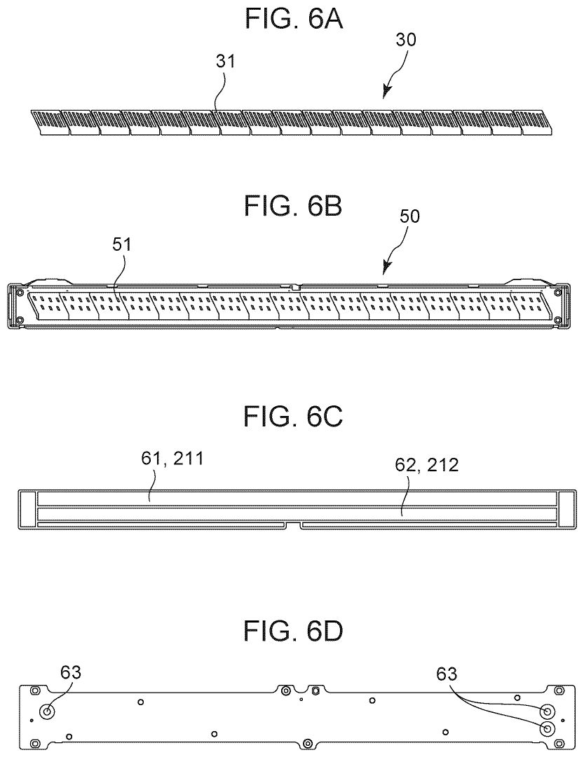

FIGS. 6A to 6D are views illustrating a detailed configuration of the channel member 210. FIG. 6A illustrates a support member 30 that is disposed on a surface of the first channel member 50 on which the ejection module 200 is mounted. FIG. 6B illustrates a surface of the first channel member 50 in contact with the support member 30. FIG. 6C is a cross-sectional view of the first channel member 50 taken in a direction perpendicular to the Z direction at a position around the center in the Z direction. FIG. 6D illustrates a surface of the second channel member 60 in contact with the liquid ejection unit support 81. FIGS. 6A to 6C are views viewed from the side of the ejection module 200. FIG. 6D is a view viewed from the side of the liquid ejection unit support 81.

The first channel member 50 has a plurality of support members 30 arranged in the Y direction on a surface away from the second channel member 60, and the support members 30 each have one element substrate 10. The liquid ejection heads 1 of various sizes can be produced by adjusting the number of ejection modules 200.

As illustrated in FIG. 6A, the support member 30 has a communication hole 31 in the surface in contact with the element substrate 10. The hole 31 is connected to the element substrate 10 so as to allow circulation of liquid and becomes the individual supply channel 213a and individual collection channel 213b described above with reference to FIG. 3. As illustrated in FIG. 6B, the communication hole 31 is connected to the common supply channel 211 or the common collection channel 212 through a communication hole 51 in the channel member 50 so as to allow circulation of liquid.

As illustrated in FIG. 6C, in the middle layer around the center of the first channel member 50 in the Z direction, common channel grooves 61 and 62, which become the common supply channel 211 and the common collection channel 212 described with reference to FIGS. 3A and 3B, extend in the Y direction. As illustrated in FIG. 6D, the common channel grooves 61 and 62 each have, at each end or one end, a common communication hole 63 in communication with the liquid supply unit 220 so as to allow circulation of liquid.

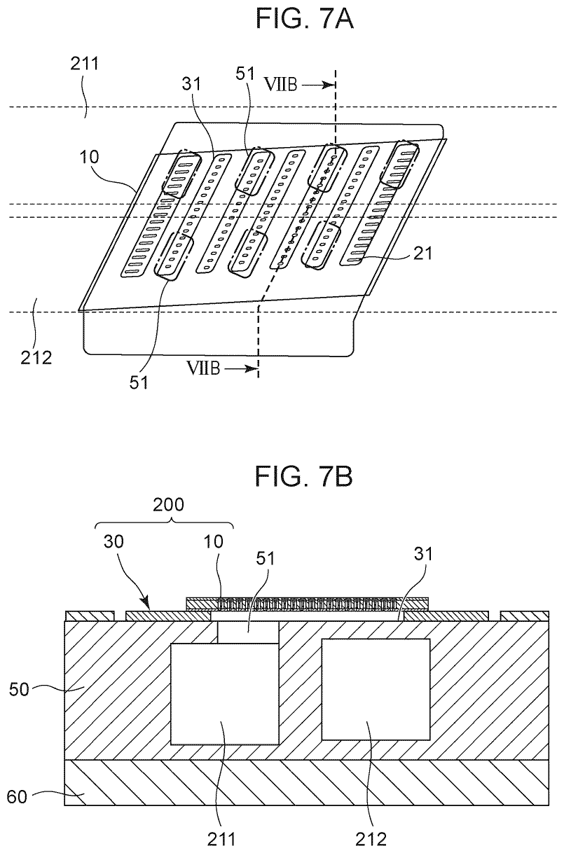

FIG. 7A and FIG. 7B are a transparent view and a cross-sectional view, respectively, illustrating the configuration of the channel formed in the liquid ejection unit 300. FIG. 7A is a magnified transparent view of the channel member 210 viewed in the Z direction, and FIG. 7B is a cross-sectional view taken along line VIIB-VIIB in FIG. 7A.

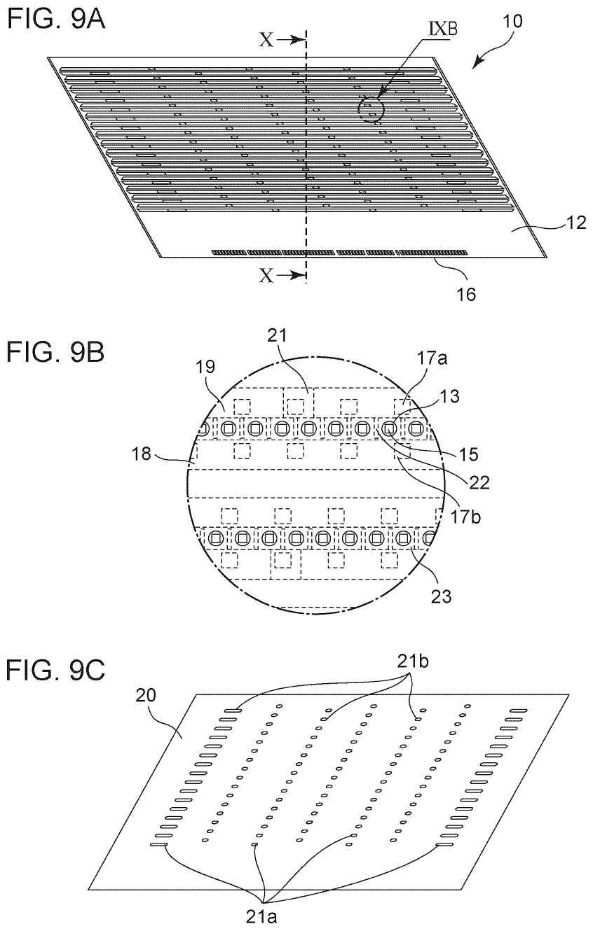

The element substrate 10 of the ejection module 200 is placed on the communication hole 51 of the first channel member 50 with the support member 30 therebetween. In FIG. 7B, only the communication hole 51 for the common supply channel 211 is illustrated, but in another cross-section, the common collection channel 212 is in communication with the communication holes 51 as illustrated in FIG. 6. The support member 30 and the element substrate 10 included in each of the ejection modules 200 have a channel for supplying ink from the first channel member 50 to the heat generating resistor 15 (see FIG. 9) on the element substrate 10. Furthermore, the support member 30 and the element substrate 10 have a channel to collect (reflux) some or all of the liquid supplied to the heat generating resistor 15 into the first channel member 50.

As described above, the common supply channel 211 is connected to the negative pressure control unit 230H set at a relatively high pressure, and the common collection channel 212 is connected to the negative pressure control unit 230L set at a relatively low pressure. This forms an ink supply route that extends through the common communication hole 63 (see FIG. 6), the common supply channel 211, and the communication hole 31 and through which ink is supplied to the channel in the element substrate 10. Similarly, this forms an ink collection route that extends from the channel in the element substrate 10 and has the communication hole 31, the communication hole 51, the common collection channel 212, and the common communication hole 63 (see FIG. 6D). While the ink is circulating in this way, the ejection action is performed in the element substrate 10 in accordance with the ejection data. Among the ink supplied through the ink supply route, ink that has not been used by the ejection operation is collected through the ink collection route.

### Configuration of Ejection Module

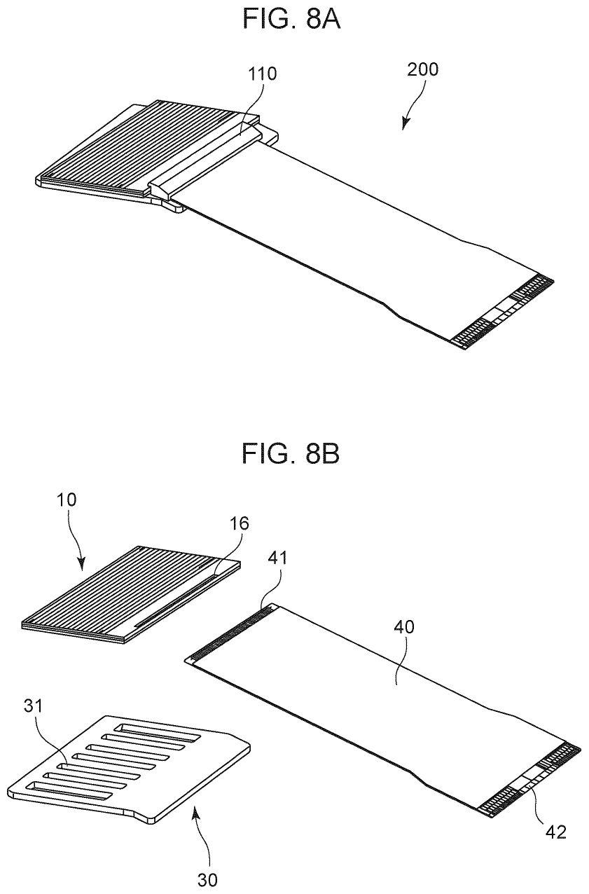

FIG. 8A is a perspective view illustrating one ejection module 200, and FIG. 8B is an exploded view of the ejection module 200. To produce the ejection module 200, the element substrate 10 and the flexible wiring board 40 are first bonded to the support member 30 that has the communication holes 31 formed in advance. Then, a terminal 16 on the element substrate 10 and a terminal 41 on the flexible wiring board 40 are electrically connected to each other by wire bonding, and then the wire bonded portion (electrically connected portion) is covered and sealed with a sealant 110. A terminal 42 on a side of the flexible wiring board 40 that is away from the element substrate 10 is electrically connected to a connection terminal 93 (FIG. 5) of the electrical wiring board 90. The support member 30, which is a support for the element substrate 10, also functions as a channel member that communicates between the element substrate 10 and the channel member 210 so as to allow circulation of liquid and thus may be a member having high flatness and can be bonded to the element substrate with sufficiently high reliability. The support member 30 may be formed of alumina or a resin material, for example.

### Configuration of Element Substrate

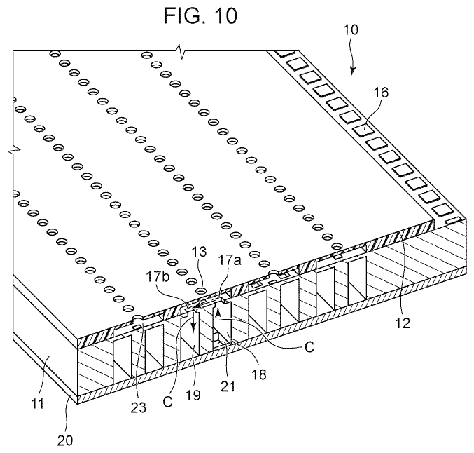

A configuration of the element substrate 10 according to this embodiment will be described. FIG. 9A is a plan view illustrating a surface of the element substrate 10 that has the discharge ports 13, FIG. 9B illustrates a magnified view of a portion indicated by IXB in FIG. 9A, and FIG. 9C is a plan view illustrating the surface opposite the surface illustrated in FIG. 9A. FIG. 10 is a cross-sectional perspective view of the element substrate 10 taken along line X-X in FIG. 9A. Hereinafter, the direction in which the array of the discharge ports 13 extends is referred to as the discharge port array direction.

As illustrated in FIG. 9B, the heat generating resistors 15, which are heating elements (pressure-generating elements) configured to generate bubbles in liquid by using thermal energy, are disposed at positions corresponding to the discharge ports 13. Partition walls 22 define the pressure chambers (liquid chambers) 23 each housing the heat generating resistor 15. The heat generating resistor 15 is electrically connected to the terminal 16 by electrical wiring (not illustrated) on the element substrate 10. The heat generating resistor 15 generates heat based on pulse signals input from the control circuit of the liquid ejection apparatus 1000 via the electrical wiring board 90 (see FIG. 5) and the flexible wiring board 40 (see FIG. 8) to boil the liquid. The liquid is ejected through the discharge port 13 by the bubbling force caused by the boiling. As illustrated in FIG. 9B, a liquid supply path 18 and a liquid collection path 19 extend along each discharge port array with the discharge port array therebetween. The liquid supply path 18 and the liquid collection path 19 are channels extending in the discharge port array direction in the element substrate 10 and in communication with the discharge ports 13 via supply ports 17a and collection ports 17b, respectively.

In an example illustrated in FIGS. 9A to 9C, the element substrate 10 has 16 discharge port arrays.

As illustrated in FIGS. 9C and 10, a cover plate 20 having a sheet-like shape is disposed on a surface of the element substrate 10 opposite the surface having the discharge ports 13. As illustrated in FIG. 9C, the cover plate 20 has multiple openings 21 in communication with the liquid supply path 18 and the liquid collection path 19, which will be described later. In this embodiment, the cover plate 20 has four supply openings 21a for one liquid supply path 18 and three collection openings 21b for one liquid collection path 19. However, the number of openings should not be limited to this. As illustrated in FIG. 9B, the openings 21 in the cover plate 20 are in communication with the corresponding communication holes 51 illustrated in FIG. 7A. The cover plate 20 may be formed of a material having sufficiently high corrosion resistance to liquid, and the opening 21 is required to have high shape accuracy and high positioning accuracy such that the ink is supplied to the pressure chamber. Thus, the cover plate 20 may be formed of a photosensitive resin material or silicon plate, and the openings 21 may be formed by photolithography technology. The cover plate 20 can change the channel pitch by using the openings 21. The cover plate may be formed of a film-like member having a thickness of about 30 to 600 μm in view of pressure loss, strength, and processability.

Next, the flow of liquid in the element substrate 10 will be described. In FIG. 10, a discharge port forming member 12 of the element substrate 10 has four discharge port arrays. However, the number of discharge port arrays should not be limited to four and may be selected as appropriate. The element substrate 10 is a stack of a substrate 11 formed of silicon and the discharge port forming member 12 formed of a photosensitive resin. The cover plate 20 is bonded to the rear surface of the substrate 11. The cover plate 20 functions as a lid that forms a part of the wall of the liquid supply path 18 and the liquid collection path 19 in the substrate 11 of the element substrate 10. The element substrate 10 has the heat generating resistor 15 on a surface of the substrate 11 (see FIG. 9) and has grooves that constitute the liquid supply path 18 and the liquid collection path 19 extending along the discharge port array on the other surface. The liquid supply path 18 and the liquid collection path 19 defined by the substrate 11 and the cover plate 20 are connected to the common supply channel 211 and the common collection channel 212 in the channel member 210, respectively (see FIG. 7). There is a differential pressure between the liquid supply path 18 and the liquid collection path 19. The differential pressure forms a circulating flow C in which the liquid in the liquid supply path 18 in the substrate 11 flows through a supply port 17a, and the pressure chamber 23, and a collection port 17b to the liquid collection path 19 (flow indicated by arrows C in FIG. 10). This flow allows, in the discharge port 13 and the pressure chamber 23 that are not in the ejection operation, thickened ink, foam, and foreign substances generated by evaporation from the discharge port 13 to be collected into the liquid collection path 19. The flow also reduces thickening of the ink in the discharge port 13 and the pressure chamber 23 and reduces an increase in the density of the coloring material. As illustrated in FIG. 7, the liquid collected into the liquid collection path 19 flows through the opening 21 in the cover plate 20 and the communication hole 31 in the support member 30 to the common collection channel 212 through the communication hole 31 in the support member 30 and the communication hole 51 in the first channel member 50 in this order, and then the liquid is collected into the supply route of the liquid ejection apparatus 1000.

In other words, the liquid supplied from the main body of the liquid ejection apparatus to the liquid ejection head 1 flows in the order below to be supplied and collected. First, the liquid flows into the liquid ejection head 1 from the liquid connection portion 111 of the liquid supply unit 220. Then, the liquid flows sequentially through the joint rubber 100, the common communication hole 63 in the second channel member, and the common channel groove 61 and the communication hole 51 in the first channel member. Then, the liquid flows sequentially through the communication hole 31 in the support member 30, the opening 21 in the cover plate 20, and the liquid supply path 18 and the supply port 17a in the substrate 11 to the pressure chamber 23. Some of the liquid in the pressure chamber 23 not ejected through the discharge port 13 flows sequentially through the collection port 17b and the liquid collection path 19 in the substrate 11, the opening 21 in the cover plate 20, and the communication hole 31 in the support member 30. Then, the liquid flows sequentially through the communication hole 51 and the common channel 62 in the first channel member, the common communication hole 63 in the second channel member, and the joint rubber 100. The liquid then flows through the liquid connection portion 111 in the liquid supply unit to the outside of the liquid ejection head 1.

In the circulation route illustrated in FIG. 3, the liquid coming in from the liquid connection portion 111 flows into the joint rubber 100 through the negative pressure control unit 230.

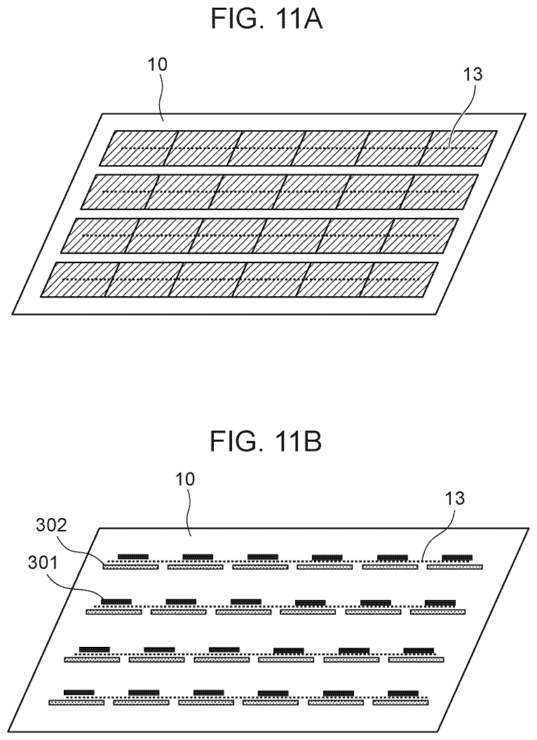

The liquid ejection head of this embodiment further includes a temperature control unit on the element substrate 10. FIGS. 11A and 11B are schematic views illustrating how the element substrates 10 are each divided into multiple areas for temperature control.

Each area has a temperature sensor 301 and an individually controllable sub-heater 302. The controller 500 (see FIG. 2) uses the temperature sensor 301 and the sub-heater 302 to adjust the temperature in accordance with the temperature (target temperature) set for each area. In other words, the controller 500 drives the sub heater 302 only in areas where the temperature detected by the temperature sensor 301 is below a target temperature. The target temperature of the element substrate 10 may be set to a somewhat higher temperature to lower the viscosity of the ink, which allows better ejection operation and circulation. Such a temperature control keeps temperature variations in the element substrate 10 and temperature variations among the element substrates 10 within a predetermined range. This reduces variations in ejection volume caused by temperature variations, resulting in less uneven density in the recorded image. The target temperature of the element substrate 10 may be set to a temperature equal to or greater than the equilibrium temperature of the element substrate 10 when all the heat generating resistors 15 are driven at the highest expected drive frequency. Examples of the temperature sensor 301 include a diode sensor and an aluminum sensor. As a heater of the element substrate 10, the heat generating resistor 15, which is a heating element, can also be used. Specifically, a voltage that is low enough not to generate a bubble may be applied to the element substrate 10 to heat the heat generating resistor 15. For example, as the heater, the heat generating resistor 15 may be employed instead of the sub-heater 302, or the sub-heater 302 and the heat generating resistor 15 may be used together.

### Positional Relationship Between Element Substrates

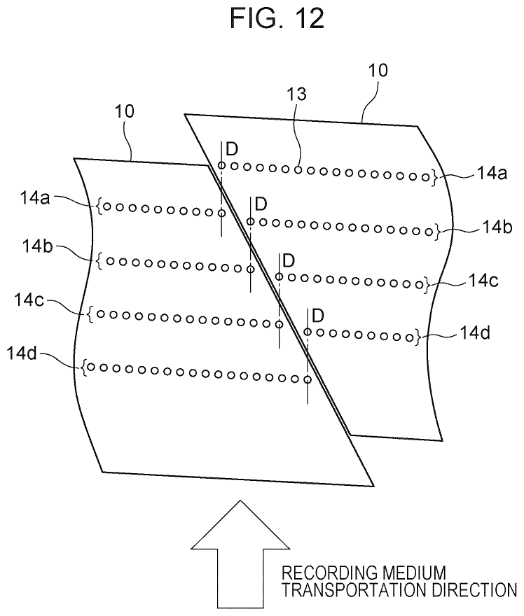

FIG. 12 is a partial magnified plan view illustrating adjacent portions of the element substrates of two adjacent ejection modules. As illustrated in FIG. 9A, the element substrate has a substantially parallelogram outer shape in this embodiment. As illustrated in FIG. 12, the discharge port arrays (14a to 14d) each including the discharge ports 13 of the element substrate 10 are inclined at a certain angle with respect to the transportation direction of the recording medium. With this configuration, the discharge port arrays of adjacent element substrates 10 each have at least one discharge port that overlaps with a discharge port of the adjacent element substrate 10 in the transportation direction of the recording medium. In FIG. 12, the two discharge ports on the D line overlap with each other. Even when the element substrate 10 is positioned slightly away from the predetermined position, this arrangement enables black stripes or white spots in the recorded image less noticeable by control of ejection through the overlapping discharge ports. In other words, the element substrates 10 may be arranged in a straight line (in-line), instead of in a staggered arrangement, to reduce the increase in the length of the liquid ejection head 1 in the transportation direction of the recording medium 3. In such a case, the configuration illustrated in FIG. 12 can prevent black stripes or white spots at the joints between the element substrates 10 while reducing the increase in the length of the liquid ejection head 1 in the transportation direction of the recording medium. In this embodiment, the main plane of the element substrate 10 is parallelogram, but the present disclosure should not be limited to this. The configuration of the present disclosure is applicable even when the element substrate has another shape, such as a rectangular shape and a trapezoidal shape.

### Liquid Flow Near Pressure Chamber

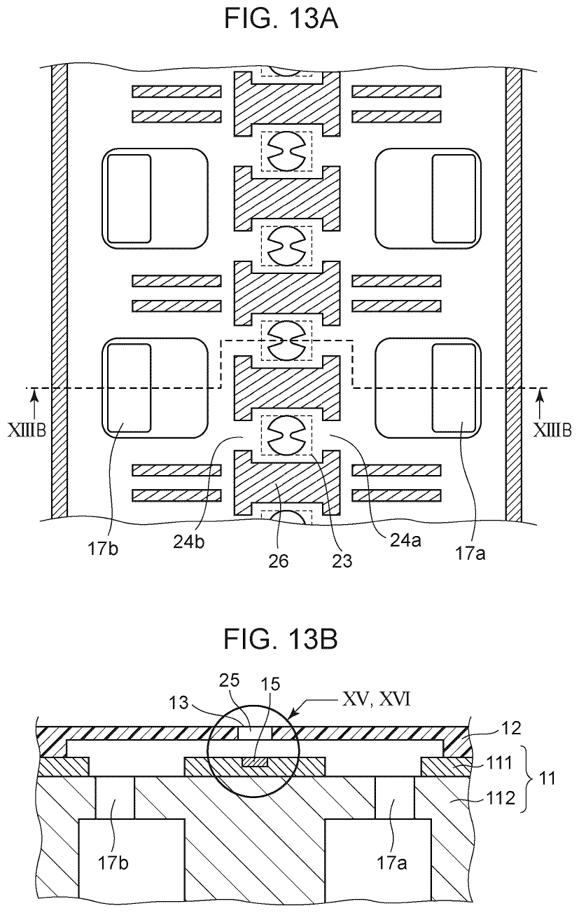

FIGS. 13A and 13B illustrate the inside of the liquid ejection head. FIG. 13A is a plan view (transparent view) illustrating the heat generating resistor and the channels. FIG. 13B is a cross-sectional view taken along line XIIIB-XIIIB in FIG. 13A. Between the substrate 11 of the element substrate 10 and the discharge port forming member 12, there are multiple pressure chambers 23 each having the discharge ports 13, and an inlet channel 24a and an outlet channel 24b, which are in communication with the corresponding pressure chambers 23. The pressure chambers 23 are separated from each other by walls 26. The substrate 11 is configured to create a circulating flow C in which the liquid in the liquid supply path 18 flows to the liquid collection path 19 through the supply port 17a, the inlet channel 24a, the pressure chamber 23, the outlet channel 24b, and the collection port 17b. The velocity of the circulating flow C in the pressure chamber is, for example, 1.0 mm/s or greater and 250 mm/s or less, which has little impact on the landing accuracy even if the ejection operation is performed while the liquid is flowing. As illustrated in FIG. 13B, the discharge port 13 is an opening at the end of the cylindrical nozzle 25 of the discharge port forming member 12. The nozzle 25 communicates between the discharge port 13 and the pressure chamber 23. The direction in which the liquid is ejected through the discharge port 13 (the vertical direction in FIG. 13B) is referred to as an ejection direction, and the direction in which the liquid flows in the pressure chamber 23 (left and right direction in FIG. 13B) is simply referred to as a flow direction.

In an example described below, the liquid to be ejected is ink having a non-volatile solvent concentration of 10 wt % or greater and 20 wt % or less, a pigment concentration of 3 wt % or greater and 10 wt % or less, a solid content concentration of 10 wt % or greater and 30 wt % or less, and a viscosity of 0.003 Pa·s or greater and 0.006 Pa·s or less. Here, the solid content concentration refers to the concentration of a pigment, a resin, and wax in the ink. The conditions of the liquid applicable to the liquid ejection head and the method for ejecting liquid of the present disclosure should not be limited to the above.

The supply ports 17a form a supply port array and the collection ports 17b form a collection port array. The discharge port array in which the discharge ports 13 are arranged is located between the supply port array and the collection port array.

In this embodiment, as described above, there is a difference in pressure between the liquid supply path 18 and the liquid collection path 19. The difference in pressure creates the circulating flow C in which the ink flows from the supply port 17a to the pressure chamber 23 through the inlet channel 24a and to the collection port 17b through the outlet channel 24b.

The heat generating resistor 15 that generates thermal energy is provided on the bottom of the pressure chamber 23 that faces the discharge port (outlet) 13. The nozzle (outlet portion) 25 extends through the discharge port forming member 12 at a position facing the pressure chamber 23. The outer end of the nozzle 25, i.e., the end away from the heat generating resistor 15, is the discharge port 13 through which ink is ejected. The nozzle 25 or the discharge port 13 is located to face the heat generating resistor 15. In this specification, the discharge port 13 is an opening in the outer surface of the discharge port forming member 12 that faces the recording medium, and the nozzle 25 is the portion communicating between the discharge port 13 and the pressure chamber 23, i.e., a through hole extending through the discharge port forming member 12.

As illustrated in FIG. 13B, the present embodiment does not have a filter, such as a filter having a columnar shape, which is often provided in the channel of the liquid ejection head to prevent foreign substance such as dust from entering the pressure chamber. In this configuration, the flow resistance in the channel is smaller, and thus the ink refill performance is improved, resulting in advantages such as an increase in the ejection frequency. In this disclosure, the filter can be omitted because foreign substances can be trapped by the channel in the discharge port forming member (the inlet channel 24a) having a relatively low height, as described below.

### Shape of Discharge Port

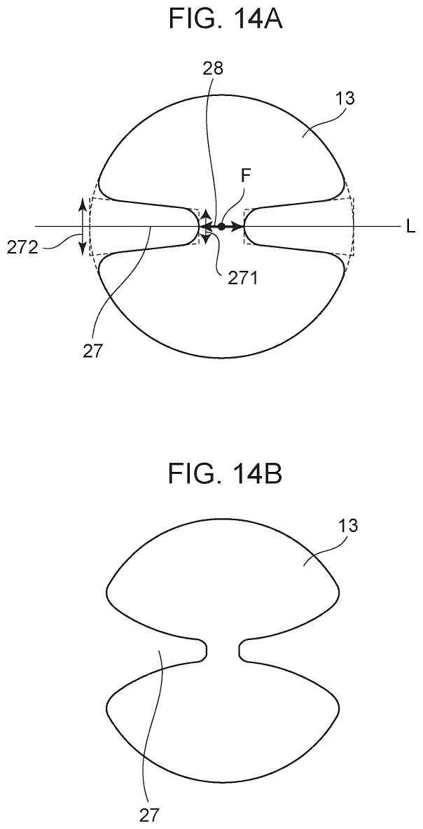

FIG. 14A is a plan view illustrating the shape of the discharge port of this embodiment, and FIG. 14B is a plan view illustrating another example of the shape of the discharge port. As illustrated in FIG. 14A, in this embodiment, two projections 27 having the same shape are located on opposite sides of the center F on a straight-line L extending through the center F of the discharge port 13 to project toward the center F. This shape can provide the effect of shortening the tail of the ejected droplets. Specifically described, the meniscus of ink formed between the projections 27 is more likely to remain than meniscus in other areas. This allows the tail of droplet extending from the discharge port 13 to be cut off at an earlier time, suppressing the generation of mist, i.e., minute droplets generated together with the main droplet. In some of FIGS. 1 to 13, the discharge port 13 is illustrated without the projections 27. If a distance 28 between the projections 27 becomes large, the tail of the ejected droplet becomes longer, and a small satellite is more likely to be generated. Thus, the distance 28 is preferably 7.0 μm or less, and more preferably 5.0 μm or less. However, if the distance 28 is too small, formation of the projections may be difficult, or the ejected droplet may be separated into two, and thus the distance 28 may be 2.0 μm or greater. In other words, the distance 28 is preferably 2.0 μm or greater and 7.0 μm or less and is more preferably 2.0 μm or greater and 5.0 μm or less. In an example of this embodiment, the distance 28 is 3.0 μm.

If the tip of the projection 27 (adjacent to the center F) is thick, the ejected droplet may be separated by the projection 27 into two droplets. In view of this, the projection 27 may have a tip width 271 of 4.0 μm or less. In an example of this embodiment, the tip width 271 is 2.0 μm. As in the present embodiment illustrated in FIG. 14A, the projection may have a rounded tip. In such a case, as indicated by a dotted line in FIG. 14A, the tip width 271 can be considered to be the length of a segment of the line extending orthogonal to the straight-line L at the tip of the projection and between points of intersections of the line with two lines extended from the long sides of the projection. In addition, the projection 27 may have a base width 272 larger than the tip width 271 to increase the strength of the projection 27. In an example of the embodiment, the base width 272 is 4.0 μm. As the embodiment illustrated in FIG. 14A, the discharge port 13 may have a curved base at the bottom of the projection 27. In such a case, as indicated by a dotted line in the figure, the base width 272 can be considered to be the length of a segment of the outer circumferential line of the circular discharge port 13 between points of intersection of the line with two lines extended from the long sides of the projection. As described above, from the viewpoint of droplet formation, the projection 27 may have a shape tapered from the base toward the tip, such as an arc-like shape illustrated in FIG. 14B.

The two projections 27 may extend in a direction substantially parallel to the transportation direction (X direction) of the recording medium 3. Since the projections 27 have a very large impact on droplet ejection, a slight manufacturing variation in the shape of the two projections makes the droplet to fly away in the direction toward one of the projections, deviating the landing position. In general, the deviation of the landing position in the discharge port array direction (Y direction) is more visible on the image than the deviation in the transportation direction (X direction) of the recording medium. Thus, the projection direction of the projection is made substantially parallel to the transportation direction of the recording medium 3 to reduce deviation in the discharge port array direction, keeping high quality printing. The projection 27 may extend in the direction in which the liquid flows in an area around the pressure chamber. In other words, the straight-line L on which the projection is located may form an angle of 45 degrees or less with respect to a flow path axis connecting the liquid supply path 18 and the liquid collection path 19 or connecting the inlet channel 24a and the outlet channel 24b.

The present embodiment includes two projections 27 extending toward the center F of the discharge port. However, the reliable drop formation can also be achieved by only one projection 27. In such a case, however, the droplet may be deviated toward a position not having the projection 27, lowering the stability of the landing position. Thus, the two projections 27 may extend toward the center F of the discharge port. The present disclosure is also applicable to a liquid ejection head having the discharge port without the projection 27.

Furthermore, in order to achieve high image quality with stable ejection quality, the droplet landing on the recording medium 3 may have a relatively small size and high definition. Thus, in the liquid ejection head of this embodiment, the ejection volume is set at a relatively small volume of 2.0 ng.

### Detailed Description of Liquid Ejection Process

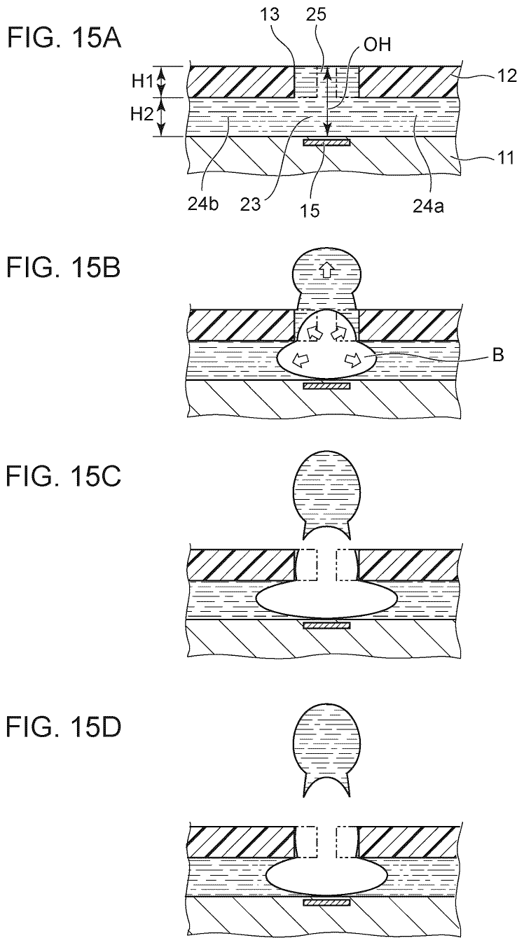

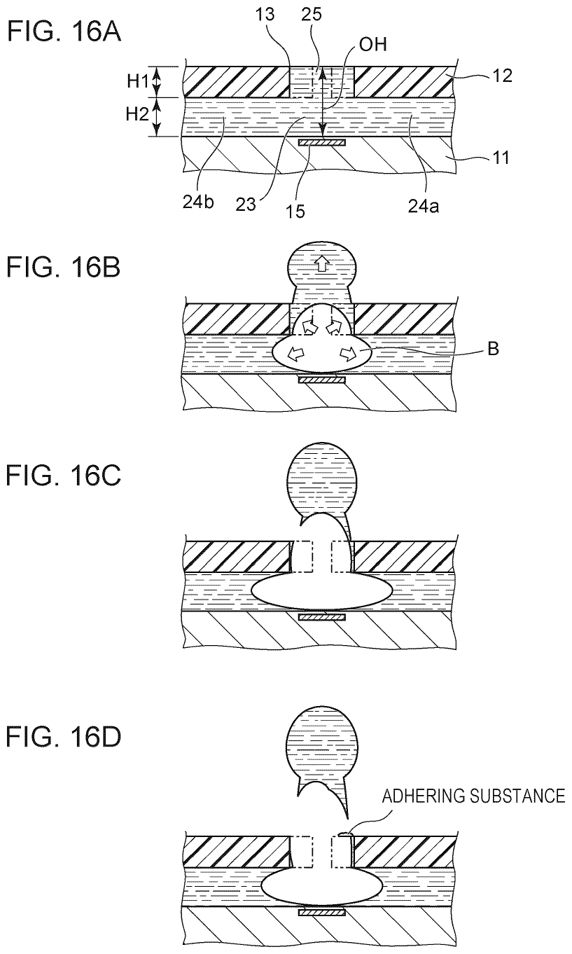

First, problems of this disclosure are explained with reference to Comparative Examples in FIGS. 15A to 15D and 16A to 16D. FIGS. 15A to 15D are schematic views illustrating a transient liquid ejection process in Comparative Example 1 of the present disclosure and corresponding to a magnified view of the portion E in FIG. 13B. The discharge port 13 has the shape indicated in FIG. 14A, and the projections 27 are indicated by dotted lines. In Comparative Example 1, the discharge port forming member 12 illustrated in FIG. 15A has a thickness H1 of 4.5 μm, and the inlet channel 24a has a height (height to the nozzle 25 of the pressure chamber) H2 of 5.0 μm. The projection distance 28 is 3.0 μm, the opening area of the discharge port 13 is about 310 μm², and the ejection volume is about 2 ng at an ejection rate of about 10 m/s. The ejection rate is the rate at which liquid is ejected through the discharge port 13.

Ink is supplied to the pressure chamber 23 from the inlet channel 24a (FIG. 15A). For ink ejection, the heat generating resistor 15 is first driven to generate thermal energy, which heats the ink around the heat generating resistor 15 and forms a bubble B (FIG. 15B).

The pressure of the nascently formed bubble B is so high that the bubble B pushes the ink between the bubble B and the discharge port 13 toward the discharge port 13 (see arrows in FIG. 15B). When the bubble B grows and enters the nozzle 25, the bubble B separates the ink droplet in the process of ejection from the ink in the channel (pressure chamber) (FIG. 15C). In Comparative Example 1, which has the discharge port 13 having the projections 27 and relatively short H1 and H2, the bubble B communicates with the atmosphere before the bubble B that has fully grown begins to decrease in volume. In this case, the bubble B does not draw the tail during contraction. This shortens the tail length and makes it difficult for the satellite to separate from the main droplet during flight (FIG. 15D).

However, since the bubble B does not draw the tail during contraction as described above, the tail may be unstable due to various disturbances. For example, fine bubbles or agglomerates in the ink may draw the tail in the circulation flow and bend the tail. FIGS. 16A to 16D are schematic views illustrating a transient liquid ejection process in Comparative Example 1 in which the tail is unstable. If the tail is unstable due to disturbance (FIG. 16C), the tail may touch the projection 27 (FIG. 16D). If the tail touches an unexpected portion of a face surface, ink may be positioned and remain on the projection to become foreign substance. The foreign substance may adhere to it. In such a case, if the ejection is continued for a long period of time without the nozzle face surface being cleaned, the foreign substance may disrupt the ejection, resulting in significant deviation of the landing position. The adhesion of foreign substance to the face surface is more likely to occur when the solid content concentration of the ink is high as in the present embodiment where the solid content concentration of the ink is 10 wt % or greater and 30 wt % or less.

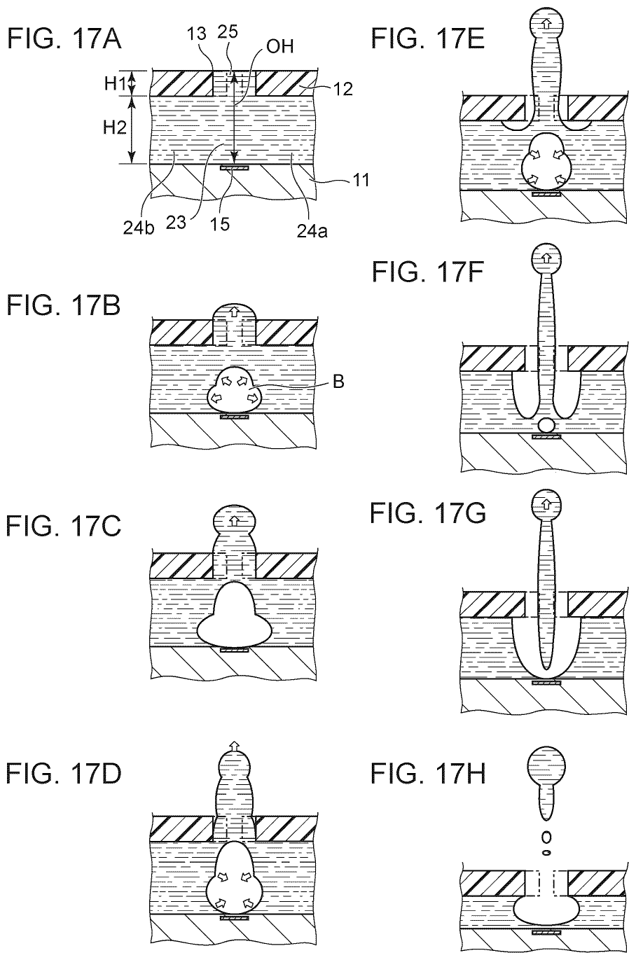

Next, Comparative Example 2 will be described. FIGS. 17A to 17H are schematic views illustrating a transient liquid ejection process in Comparative Example 2 of the present disclosure and corresponds to a magnified view of the portion E in FIG. 13B. The projections 27 of the discharge port 13 are indicated by dotted lines. The discharge port 13 has the shape indicated in FIG. 14A, and the projections 27 are indicated by dotted lines. In Comparative Example 2, H1 and H2 indicated in FIG. 17A are 6.0 μm and 16 μm, respectively. The distance (nozzle height) OH between the bottom of the pressure chamber and the discharge port 13 in Comparative Example 2 is longer than that in Comparative Example 1. The distance OH is equal to the sum of H1, which is the thickness of the discharge port forming member 12 or the height of the nozzle 25, and H2, which is the height of the inlet channel 24a in the direction perpendicular to the surface of the pressure chamber 23 that has the heat generating resistor 15. The projection distance is 3.0 μm, the area of the discharge port opening is about 166 μm², and the ejection volume is about 2 ng at an ejection rate of about 10 m/s.

As in Comparative Example 1, the heat generating resistor 15 is driven to generate thermal energy, which heats the ink around the heat generating resistor 15 and forms a bubble B (FIG. 17B). As the bubble B grows, the ink in the nozzle 25 is pushed toward the discharge port 13 (FIG. 17C).

As the bubble B grows, the internal pressure of the bubble B changes abruptly from positive pressure to negative pressure, which is lower than the atmospheric pressure (FIG. 17D). The negative pressure draws the trailing edge of the droplet toward the heat generating resistor 15 and elongates the tail (FIG. 17E). The bubble B begins to contract, and the contraction draws a portion of the liquid that becomes a tail (the trailing edge of the droplet) into the discharge port. In Comparative Example 2, the distance OH is longer than that in Comparative Example 1, and thus it takes longer for the bubble to communicate with the atmosphere. The tail is kept drawn for a relatively long time (FIG. 17F). In this case, the droplet is ejected while having a long tail length (FIG. 17G), and the droplet may be separated into a main droplet and a satellite during flight (FIG. 17H), affecting recording accuracy.

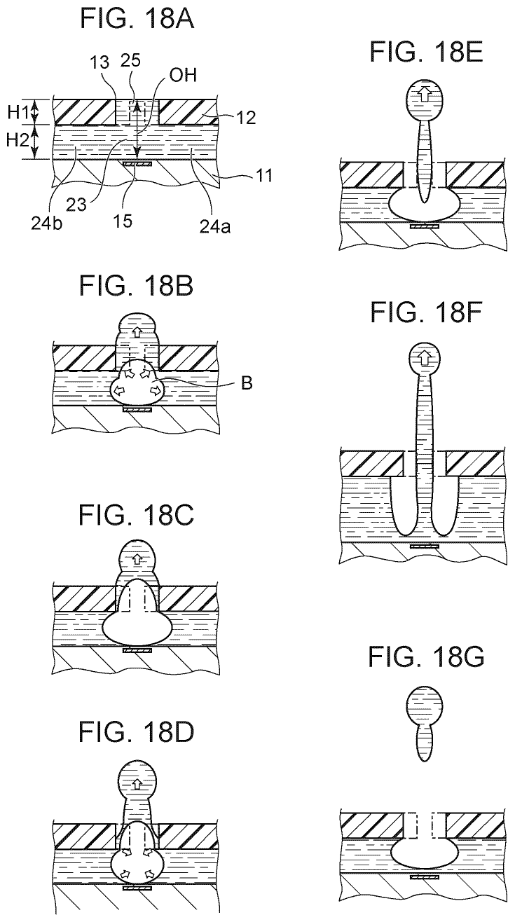

Next, the embodiment of the present disclosure will be described. FIGS. 18A to 18G are schematic views illustrating a transient liquid ejection process in the present embodiment and corresponds to a magnified view of the portion E in FIG. 13B. The projections 27 of the discharge port 13 are indicated by dotted lines. In an example of the present embodiment, H1 and H2 indicated in FIG. 18A are 6.0 μm and 8.5 μm, respectively, and OH is longer than that in Comparative Example 1 and shorter than that in Comparative Example 2. The projection distance is 3.0 μm, the area of the discharge port opening is about 200 μm², and the ejection volume is about 2 ng at an ejection rate of about 10 m/s. As in Comparative Examples 1 and 2, the heat generating resistor 15 is driven to generate thermal energy, which heats the ink around the heat generating resistor 15 and forms a bubble B (FIG. 18B). This pushes the ink between the bubble B and the discharge port 13 toward the discharge port 13 (see arrows in FIG. 18B) and then pushes the ink in the nozzle 25 toward the discharge port 13 (FIG. 18C). When the volume of the bubble B increases and the bubble B enters the nozzle 25, the bubble B separates the ink droplet in the process of ejection from the ink in the channel B (FIG. 18C).

In the present embodiment in which the distance OH is longer than that in Comparative Example 1, the trailing edge of the ejected ink droplet heads toward the heat generating resistor 15 as the bubble B that has grown to its maximum volume contracts (FIG. 18D). At this time, at least a portion of the bubble B that has entered the nozzle has a velocity component toward the surface of the pressure chamber that has the heat generating resistor 15. The contraction of the bubble B draws the tail of the ink droplet toward the heat generating resistor 15, resulting in stable tail generation. This reduces the contact of the tail with the discharge port 13 and the projection 27, for example.

Thus, foreign substance is less likely to adhere to the discharge port 13 and the projection, and thus the ejection can be stably continued even if the nozzle face surface is not cleaned for a long period of time. Although the tail is elongated as the bubble B contracts, the bubble communicates with the atmosphere at a relatively early timing (FIG. 18E) before the trailing edge, which is a portion to be the tail of the droplet, comes in contact with the surface (bottom) of the pressure chamber that has the heat generating resistor 15, because the distance OH is shorter than that in Comparative Example 2. This enables ejection with less satellite (FIG. 18G).

As described above, when OH is short as in Comparative Example 1, the tail length is short, and thus the satellite generation is suppressed. However, the stability of the tail is lost, and thus ejection defects are likely to occur during long-term continuous ejection. In contrast, when OH is long as in Comparative Example 2, the stability of the tail is increased and the stability is maintained during long-term continuous ejection. However, the tail is likely to be long, which is likely to deteriorate the droplet formation and readily cause satellite generation. Here, the thickness H1 of the discharge port forming member 12 and the height of the inlet channel 24a (height of the pressure chamber) H2 are explained in detail in terms of stability of the tail.

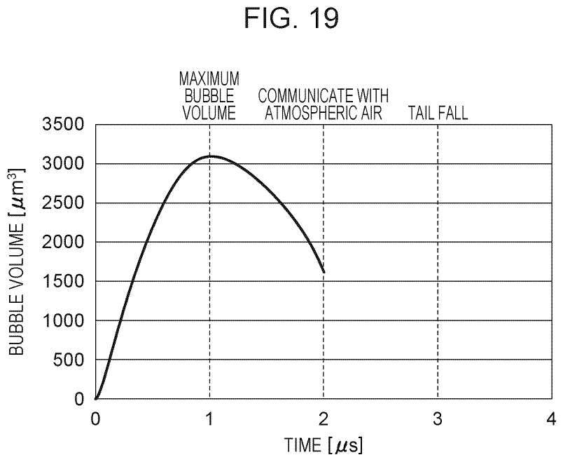

FIG. 19 indicates the size of the bubble in the transient ejection process in the present embodiment illustrated in FIGS. 18A to 18G. The horizontal axis represents the time elapsed from the start of generation of the bubble B (see FIG. 18). The vertical axis represents the volume of the bubble B. The bubble B formed by thermal energy increases in volume immediately after the generation due to its inertia. In this embodiment, the volume of the bubble reaches its maximum at about 1 us from the start of bubble generation. Then, the bubble B begins to contract due to the negative pressure of the bubble, and the bubble is in communication with the atmosphere at about 2 us from the start of bubble generation in this embodiment. The tail is more stably drawn by the bubble when the bubble B communicates with the atmosphere after contracted as in the present embodiment than when the bubble B communicates with the atmosphere before the start of contraction as in Comparative Example 1. As can be seen from the above, in the ejection of droplets, the bubble B may communicate with the atmosphere after a sufficient time has elapsed since it reached its maximum volume. The value of Tₜₕ−Tₘₐₓ may be sufficiently big where Tₘₐₓ is the time from when generation of the bubble starts until the volume of the bubble reaches its maximum value, and Tₜₕ is the time from when generation of the bubble starts until the bubble communicates with the atmosphere.

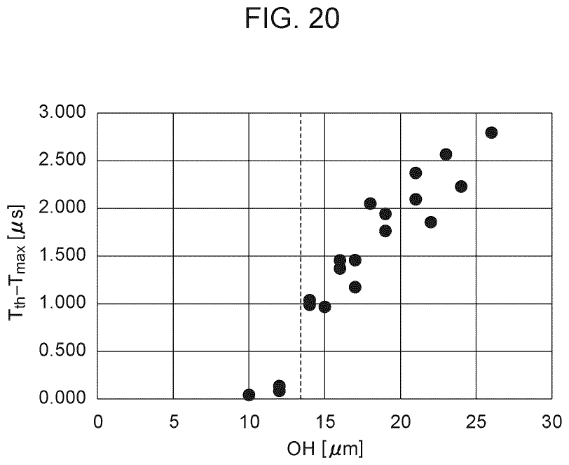

FIG. 20 indicates the relationship between OH and Tₜₕ−Tₘₐₓ. The conditions other than the height OH are the same at each point. The projection distance of the discharge port 13 is 3.0 μm, the ejection rate is about 10 m/s, and the ejection volume is about 2 ng. As can be seen from FIG. 20, Tₜₕ−Tₘₐₓ increases significantly when OH exceeds 13 μm. This indicates that OH may be 13 μm or greater to ensure sufficient time from the time when the bubble volume reaches its maximum value until the bubble communicates with the atmosphere.

After the bubble communicates with the atmosphere, the tail is subsequently drawn into the nozzle 25 by the bubble and falls on the substrate 11 (FIG. 18F). In the present embodiment, the tail falls about 3 μs after the bubble generation (see FIG. 19), which is later than when the bubble communicates with the atmosphere. According to this embodiment, the bubble communicates with the atmosphere before the tail falls, which requires a shorter time to draw the tail. Thus, the increase in tail length is reduced, and the generation of satellites can be reduced. T_{fall}−Tₜₕ may be greater than or equal to 0, where T_{fall} is the time at which the tail fell.

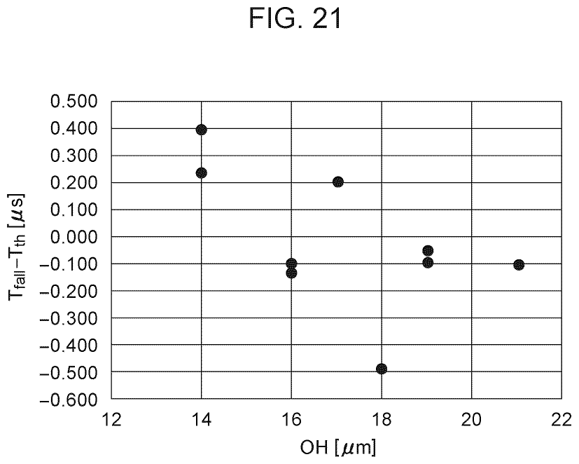

FIG. 21 indicates the relationship between OH and T_{fall}−Tₜₕ. As in FIG. 20, the conditions other than OH are the same at each point. The projection distance of the discharge port 13 is 3.0 μm, the ejection rate is about 10 m/s, and the ejection volume is about 2 ng. As can be seen from FIG. 21, T_{fall}−Tₜₕ is almost 0 when OH is about 16 μm. This indicates that OH may be 16 μm or less.

If H1 is too small, the projection will have lower strength and break easily. Thus, H1 may be 4 μm or greater. If H1 is too large, thickening near the discharge port is less suppressed by circulation. Thus, H1 may be about 10 μm or less. If H2 is too small, it will be difficult to supply ink to the discharge port. Thus, H2 may be about 5 μm or greater.

The height OH described with reference to FIGS. 19 to 21 is all based on the results of simulation performed under the following conditions: a projection distance of the discharge port 13 is 3.0 μm, an area of the ejection opening is about 200 μm², an ejection rate is about 10 m/s, and an ejection volume is about 2 ng. However, the above height OH should not be limited to those under the above-described conditions of this embodiment. Since the droplet ejection behavior is mainly affected by the ejection rate and viscosity of the liquid, the height OH (13 μm or greater and 16 μm or less) can be employed as long as the ejection rate and viscosity of the liquid are at least within the range indicated in this specification. Specifically, when the height OH is employed, the viscosity of the liquid is 0.002 Pa·s or greater and 0.010 Pa·s or less (2 cP or greater and 10 cP or less) at 25° C., and the ejection rate is 7.0 m/s or greater and 12 m/s or less.

As described above, the droplet formation is affected not only by the length of OH, but also by the ejection rate of the ink droplet. If the ejection rate is too high, the tip of the main droplet is ejected much ahead of the tail, and the tail tends to come off and become a satellite. In view of this, the ejection rate may be 12 m/s or less.

In the liquid ejection head of the present disclosure, which has the projection 27 in the discharge port 13, the viscosity of the ink near the discharge port increases as the moisture near the discharge port evaporates, and thus the liquid ejection head is more likely to have ejection defect than a liquid ejection head that has no projection in the discharge port. This is due to the fact that the discharge port having the projections has a longer perimeter than a circular nozzle and a larger resistance is caused when the liquid is ejected through the discharge port 13. In particular, inkjet printers used in commercial and industrial fields that require better droplet formation use inks having a high solid content concentration in view of image fastness and color reproduction, and the ejection defects associated with ink concentration caused by evaporation of moisture in the ink become more pronounced in some cases. The ink concentration can be prevented by increasing the ejection rate. However, if the ejection rate is too high, the tail tends to come off and become a satellite as described above. In view of the above, in the liquid ejection head of this embodiment, the inlet channel 24a and the outlet channel 24b are provided for the pressure chamber, and ink inside the pressure chamber can be circulated by the differential pressure between the inlet channel 24a and the outlet channel 24b (see FIGS. 13A and 13B). As a result, even if moisture near the discharge port 13 evaporates, fresh ink that has not yet evaporated is supplied from the inlet channel 24a, enabling stable ejection without an excessive increase in ejection rate. The liquid may be circulated by using other circulating configurations than the differential-pressure configuration, such as a pump-based configuration.

The inlet channel 24a and the outlet channel 24b may have the same magnitude of flow resistance. Bubbles formed by thermal energy spread not only in the liquid ejection direction but also spread toward the inlet channel 24a and the outlet channel 24b (see FIGS. 18B and 18C). If the difference in flow resistance between the inlet channel 24a and the outlet channel 24b is large, the generated bubble will spread asymmetrically into the channels. In this case, the tail may be formed asymmetrically, and thus, when the tail contrasts to combine with the main droplet, the axis shifts, adversely affecting the droplet formation to be achieved by successful combination. In order to reduce the difference in flow resistance between the inlet channel 24a and the outlet channel 24b, the inlet channel 24a and the outlet channel 24b may have the same height in the liquid ejection direction.

The present disclosure can provide a liquid ejection head having ejection stability during long-term continuous ejection while suppressing generation of satellite by shortening the tail length and can also provide a method for ejecting liquid.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-125728, filed Aug. 1, 2023, which is hereby incorporated by reference herein in its entirety.

What is claimed is:

1. A liquid ejection head comprising:
a liquid chamber having an element that generates thermal energy for ejecting liquid;
a discharge port through which liquid is ejected;
a nozzle that communicates between the discharge port and the liquid chamber;
a liquid supply path that is in communication with the liquid chamber and through which liquid is supplied to the liquid chamber; and
a liquid collection path that is in communication with the liquid chamber on an opposite side of the liquid chamber from the liquid supply path and through which liquid is collected, wherein
the thermal energy forms a bubble in the liquid chamber, and the formed bubble enters the nozzle to eject liquid through the discharge port under pressure of the bubble, and
in a state where at least a portion of the bubble in the nozzle has a velocity component toward a surface of the liquid chamber that has the element and before liquid to be ejected through the discharge port comes in contact with the surface of the liquid chamber by being drawn into the liquid chamber by contraction of the bubble, the bubble communicates with an atmosphere and the liquid is ejected through the discharge port.

2. The liquid ejection head according to claim 1, wherein a distance between the discharge port and the surface of the liquid chamber that has the element is 13 μm or greater.

3. The liquid ejection head according to claim 1, wherein a distance between the discharge port and the surface of the liquid chamber that has the element is 16 μm or less.

4. The liquid ejection head according to claim 1, wherein the discharge port has two projections located on a straight line extending through a center of the discharge port and located on opposite sides of the center to project toward the center.

5. The liquid ejection head according to claim 1, wherein the liquid circulates between an inside and an outside of the liquid chamber.

6. A liquid ejection head comprising:
a liquid chamber having an element that generates thermal energy used to eject liquid;
a discharge port through which liquid is ejected;
a nozzle that communicates between the discharge port and the liquid chamber;
a liquid supply path that is in communication with the liquid chamber and through which liquid is supplied to the liquid chamber; and
a liquid collection path that is in communication with the liquid chamber on an opposite side of the liquid chamber from the liquid supply path and through which liquid is collected, wherein
the thermal energy forms a bubble in the liquid chamber, and the formed bubble enters the nozzle to eject liquid through the discharge port under pressure of the bubble, and
a distance between the discharge port and a surface of the liquid chamber that has the element is 13 μm or greater and 16 μm or less.

7. The liquid ejection head according to claim 6, wherein the discharge port has two projections located on a straight line extending through a center of the discharge port and located on opposite sides of the center to project toward the center.

8. The liquid ejection head according to claim 7, wherein a distance between the two projections of the discharge port is 2.0 μm or greater and 5.0 μm or less.

9. The liquid ejection head according to claim 7, wherein the projections have a width decreasing toward the center of the discharge port.

10. The liquid ejection head according to claim 6, wherein the discharge port has two projections projecting toward a center of the discharge port,
the two projections are located on a straight line extending through the center of the discharge port and located on opposite sides of the center, and
the straight line forms an angle of 45 degrees or less with respect to a flow path axis connecting the liquid supply path and the liquid collection path.

11. The liquid ejection head according to claim 6, wherein the liquid circulates between an inside and an outside of the liquid chamber.

12. A method for ejecting liquid by using a liquid ejection head comprising a liquid chamber having an element that generates thermal energy for ejecting liquid, a discharge port through which liquid is ejected, a nozzle that communicates between the discharge port and the liquid chamber, a liquid supply path that is in communication with the liquid chamber and through which liquid is supplied to the liquid chamber, and a liquid collection path that is in communication with the liquid chamber on an opposite side of the liquid chamber from the liquid supply path and through which liquid is collected, the method comprising:
generating a bubble in liquid in the liquid chamber by using the element;
moving the generated bubble into the nozzle; and
ejecting liquid through the discharge port under pressure of the generated bubble, wherein
the bubble communicates with an atmosphere when the bubble contracts and before liquid comes in contact with a surface of the liquid chamber that has the element by being drawn into the liquid chamber by the contraction of the bubble.

13. The method for ejecting liquid according to claim 12, wherein the liquid to be ejected through the discharge port has a viscosity of 0.002 Pa·s or greater and 0.010 Pa·s or less.

14. The method for ejecting liquid according to claim 12, wherein the liquid to be ejected through the discharge port has a solid content concentration of 10 wt % or greater and 30 wt % or less.

15. The method for ejecting liquid according to claim 12, wherein the liquid circulates between an inside and an outside of the liquid chamber.

16. The method for ejecting liquid according to claim 12, wherein an ejection rate at which the liquid is ejected through the discharge port is 7.0 m/s or greater and 12 m/s or less.
